(19) United States
(12) Patent Application Publication
(10) Pub. No.: US 2025/0202233 A1
(43) Pub. Date: Jun. 19, 2025

(54) PREDICTION APPARATUS, PREDICTION SYSTEM, PREDICTION METHOD, AND STORAGE MEDIUM

(71) Applicant: NEC Corporation, Minato-ku, Tokyo (JP)

(72) Inventor: Yaeko Yonezawa, Tokyo (JP)

(73) Assignee: NEC Corporation, Minato-ku, Tokyo (JP)

(21) Appl. No.: 18/846,447

(22) PCT Filed: Mar. 24, 2022
(86) PCT No.: PCT/JP2022/013814

§ 371 Date: Sep. 12, 2024

(51) Int. Cl. H02J 3/00; G05B 13/04

(52) U.S. Cl. CPC H02J 3/004; G05B 13/048

(57) ABSTRACT

A prediction apparatus (10) includes an acquisition unit (110) and a prediction unit (130). The acquisition unit (110) acquires a progression of predicted values of a first amount of electric power supply. The first amount of electric power supply is an amount of electric power supply from a source of electric power supply including at least one piece of photovoltaic power generation equipment to a supply target. In a case where a predetermined condition is satisfied, the prediction unit (130) modifies or re-predicts the progression of predicted values of the first amount of electric power supply by using an image. The image is an image acquired by capturing an image of the sky around the photovoltaic power generation equipment.

### TECHNICAL FIELD

The present invention relates to a prediction apparatus, a prediction system, a prediction method, and a storage medium.

### BACKGROUND ART

Since an amount of electric power generated by a photovoltaic power generation equipment depends on the weather and the like, development of an electric power generation prediction technology has been under way.

Patent Document 1 describes predicting fluctuations in an amount of electric power generated by a photovoltaic panel from an image of the sky captured by a camera. Patent Document 1 further describes that in a case where the magnitude of predicted fluctuations is equal to or greater than a predetermined value, fluctuations in electric power input to an electric power conversion unit are reduced by charge or discharge in a storage battery unit.

Patent Document 2 describes controlling discharge in storage battery equipment in such a way that interconnected capacity for a commercial electric power system is not exceeded, by using a result of prediction of electric power generated by electric power generation equipment. Patent Document 2 further describes predicting an amount of solar radiation by using an image directly representing a positional relation between the positions of the sun and a cloud in an unobstructed sky.

### RELATED DOCUMENTS

### Patent Documents

Patent Document 1: Japanese Patent Application Publication No. 2015-42102

Patent Document 2: Japanese Patent Application Publication No. 2019-161863

### SUMMARY

### Technical Problem

The technologies in Patent Documents 1 and 2 described above continuously require high-precision electric power generation prediction for charge-discharge control. Accordingly, the processing load for prediction is heavy.

An example of an object of the present invention is to, in view of the problem described above, provide a prediction apparatus, a prediction system, a prediction method, and a storage medium that provide a lightened processing load for predicting an amount of electric power generated by photovoltaic power generation.

### Solution to Problem

An example aspect of the invention provides a prediction apparatus including:

an acquisition unit that acquires a progression of one or more predicted values of a first amount of electric power supply from a source of electric power supply including at least one piece of photovoltaic power generation equipment to a supply target; and

a prediction unit that, in a case where a predetermined condition is satisfied, modifies or re-predicts the progression of one or more predicted values of the first amount of electric power supply by using an image acquired by capturing an image of a sky around the photovoltaic power generation equipment.

Another example aspect of the invention provides a prediction system including:

the aforementioned prediction apparatus; and

an image capture unit that captures the image of the sky around the photovoltaic power generation equipment in a case where the predetermined condition is determined to be satisfied in the prediction apparatus.

Still another example aspect of the invention provides a prediction method including, by one or more computers:

acquiring a progression of one or more predicted values of a first amount of electric power supply from a source of electric power supply including at least one piece of photovoltaic power generation equipment to a supply target; and,

in a case where a predetermined condition is satisfied, modifying or re-predicting the progression of one or more predicted values of the first amount of electric power supply by using an image acquired by capturing an image of a sky around the photovoltaic power generation equipment.

Still another example aspect of the invention provides a storage medium storing a program causing a computer to execute a prediction method including, by the computer:

acquiring a progression of one or more predicted values of a first amount of electric power supply from a source of electric power supply including at least one piece of photovoltaic power generation equipment to a supply target; and,

in a case where a predetermined condition is satisfied, modifying or re-predicting the progression of one or more predicted values of the first amount of electric power supply by using an image acquired by capturing an image of a sky around the photovoltaic power generation equipment.

### ADVANTAGEOUS EFFECTS

The example aspect of the invention provide a prediction apparatus, a prediction system, a prediction method, and a storage medium that provide a reduced processing load for predicting an amount of electric power generated by photovoltaic power generation.

### BRIEF DESCRIPTION OF THE DRAWINGS

FIG. 1 It is a diagram illustrating an overview of a prediction apparatus according to an example embodiment.

FIG. 2 It is a diagram for illustrating electric power supply to a supply target.

FIG. 3 It is a block diagram illustrating a configuration of the prediction apparatus according to the example embodiment.

FIG. 4 It is a diagram illustrating an example of a graph generated by an output unit.

FIG. 5 It is a diagram illustrating an example of an image displayed based on notification information from the output unit.

FIG. 6 It is a diagram illustrating a configuration of a prediction system according to the example embodiment.

FIG. 7 It is a diagram illustrating a computer for providing the prediction apparatus.

FIG. 8 It is a flowchart illustrating an overview of a prediction method executed by the prediction apparatus according to the example embodiment.

FIG. 9 It is a flowchart illustrating a flow of the prediction method according to the example embodiment.

### EXAMPLE EMBODIMENT

Example embodiments of the present invention will be described below by using drawings. Note that in every drawing, similar components are given similar signs, and description thereof is omitted as appropriate.

### Example Embodiments

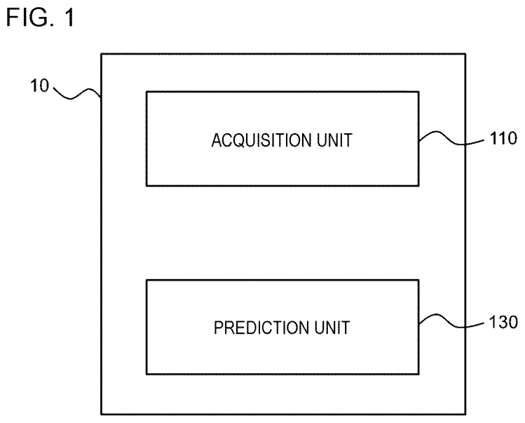

FIG. 1 is a diagram illustrating an overview of a prediction apparatus 10 according to an example embodiment. The prediction apparatus 10 includes an acquisition unit 110 and a prediction unit 130. The acquisition unit 110 acquires a progression of predicted values of a first amount of electric power supply. The first amount of electric power supply is an amount of electric power supply from a source of electric power supply including at least one piece of photovoltaic power generation equipment to a supply target. In a case where a predetermined condition is satisfied, the prediction unit 130 modifies or re-predicts the progression of predicted values of the first amount of electric power supply by using an image. The image is an image acquired by capturing an image of the sky around the photovoltaic power generation equipment.

The prediction apparatus 10 performs high-precision prediction based on an image of the sky only in a case where necessary and therefore can reduce the processing load. A detailed example of the prediction apparatus 10 will be described below.

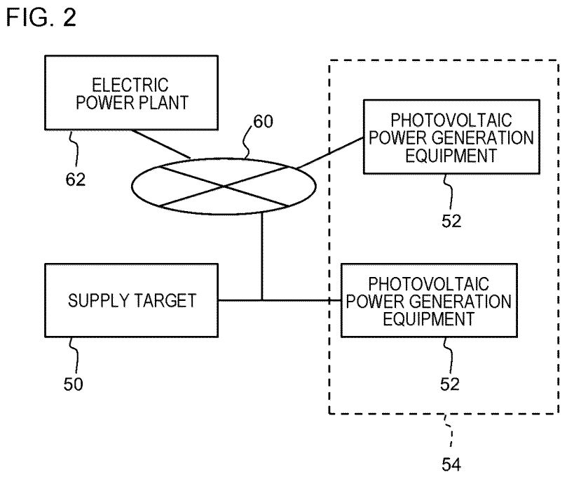

FIG. 2 is a diagram for illustrating electric power supply to a supply target 50. In recent years, use of renewable energy has been promoted. Examples of renewable energy include solar energy, wind energy, and geothermal energy. In particular, installation of photovoltaic power generation equipment 52 for use of solar energy has been under way. On the other hand, an amount of electric power supply from the photovoltaic power generation equipment 52 depends on the weather and the like. In a case where an amount of electric power demand cannot be covered solely by an amount of electric power supply from the photovoltaic power generation equipment 52, an electric power user (such as a business operator using electric power) receives supply of electric power corresponding to a shortfall from an electric power company. However, in a case where the electric power user receives supply of electric power exceeding that of contract with the electric power company, an electric power charge increases. Accordingly, in order to hold down as much electric power supply from the electric power company as possible, the electric power user needs to balance demand and supply by predicting an amount of electric power supply from the photovoltaic power generation equipment 52. Note that for example, an electric power company is a business operator performing at least one operation out of electric power supply (electric power generation), and distribution and transmission of electric power.

Further, target usage of renewable energy may be determined for an electric power user, based on various policies, systems, and the like. The target usage may be fixed or may vary with time. The electric power user preferably uses supplied electric power of renewable energy origin as exactly as possible. Accordingly, it is preferable that the electric power user predict an amount of electric power supply based on renewable energy including sunlight and adjust demand to the predicted amount of electric power supply.

For such a reason, prediction of an amount of electric power supply from the photovoltaic power generation equipment 52 is required, but on the other hand, high-precision prediction is not necessarily always required. For example, it is important to perform higher precision prediction in a situation requiring particular attention, such as a case of increase in a deviation between an amount of electric power supply predicted in advance and an actual amount of electric power supply, or a timing at which a balance between an amount of electric power supply and electric power demand is likely to be lost. Thus, required measures such as control of demand can be taken.

An electric power user may acquire renewable energy from electric power generation equipment owned by the electric power user, such as the photovoltaic power generation equipment 52, or may acquire renewable energy by purchase from another party (such as another business operator). Further, the electric power generation equipment owned by the electric power user may be inside or around a facility or the like of the supply target 50 or may be in a location distant from the supply target 50. In a case where the electric power generation equipment is inside or around the facility or the like of the supply target 50, the electric power generation equipment can directly supply electric power to the supply target 50 of electric power.

In a case where the electric power generation equipment is in a location distant from the supply target 50, electric power can be supplied from the electric power generation equipment to the supply target 50 through an electric power system grid 60 or the like. Note that for example, the electric power system grid 60 is an electric power distribution-transmission grid managed by an electric power company or the like. The supply target 50 may also receive electric power supply from an electric power company through the electric power system grid 60.

Without being particularly limited, examples of the supply target 50 include one or more facilities, one or more pieces of equipment, one or more buildings, one or more houses, one or more rooms, and one or more floors. Further, examples of the supply target 50 may include a factory and production equipment. Electric power supply is performed from a source of electric power supply 54 to the supply target 50. Further, electric power supply to the supply target 50 from a power source other than the source of electric power supply 54, such as an electric power plant 62, is also performed through the electric power system grid 60. Furthermore, in a case where an amount of electric power demand of the supply target 50 exceeds an amount of electric power supply from the source of electric power supply 54, electric power supply from the source of electric power supply 54 to the electric power system grid 60 is also performed. The source of electric power supply 54 includes at least one piece of photovoltaic power generation equipment 52. The source of electric power supply 54 may include one or more pieces of electric power supply equipment other than the photovoltaic power generation equipment 52.

The electric power supply equipment other than the photovoltaic power generation equipment 52 may be electric power generation equipment based on renewable energy or another type of electric power generation equipment. The source of electric power supply 54 may include electric power supply equipment related to so-called electricity wheeled for self-use or an off-site power purchase agreement (PPA). An amount of electric power supply from the source of electric power supply 54 is referred to as the first amount of electric power supply. The first amount of electric power supply may indicate an amount of electric power supply from the source of electric power supply 54 to the supply target 50. The supply target 50 and the source of electric power supply 54 may be further connected to charge-discharge equipment such as a storage battery. Further, electric power supply may be performed from the source of electric power supply 54 to another target. In that case, for example, a ratio of an amount of electric power supply usable by the supply target 50 to the first amount of electric power supply may be determined, and the ratio may be used for determination for the predetermined condition, which is to be described later. Electric power supply from the source of electric power supply 54 may be performed only to the supply target 50.

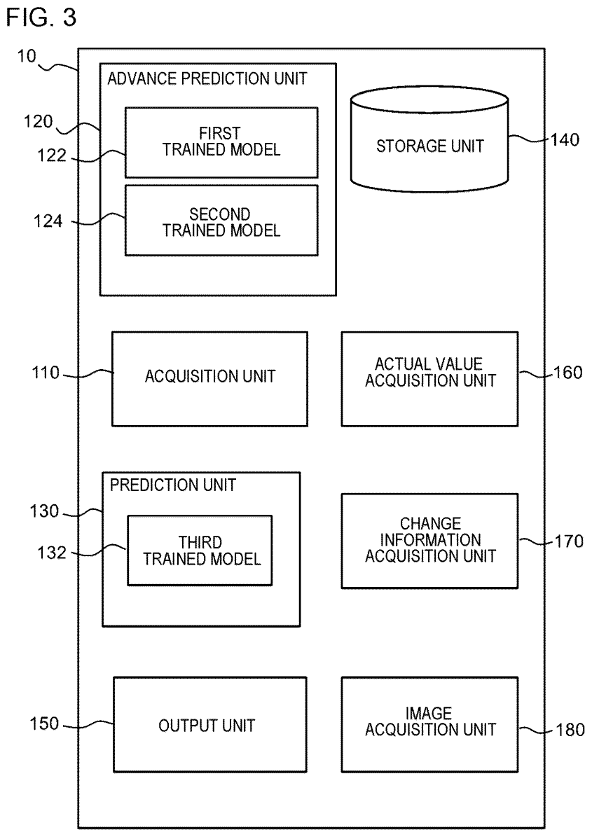

FIG. 3 is a block diagram illustrating a configuration of the prediction apparatus 10 according to the present example embodiment. The prediction apparatus 10 in the example in FIG. 3 further includes an advance prediction unit 120, an output unit 150, an actual value acquisition unit 160, a change information acquisition unit 170, an image acquisition unit 180, and a storage unit 140. The advance prediction unit 120 generates a progression of predicted values of the first amount of electric power supply in advance and causes the storage unit 140 to hold the result of the generation. While storage unit 140 is included in the prediction apparatus 10 in the example in FIG. 3, the storage unit 140 may be provided outside the prediction apparatus 10. Note that the prediction apparatus 10 may not include at least one of the actual value acquisition unit 160 and the change information acquisition unit 170 depending on a content of the predetermined condition for determination.

At a predetermined time every day, the advance prediction unit 120 predicts the first amount of electric power supply in a period predetermined on the basis of the predetermined time and generates a progression of the predicted values. For example, the advance prediction unit 120 predicts first amounts of electric power supply for the next day and the next day but one and generates a progression of the predicted values.

For example, the advance prediction unit 120 includes a first trained model 122. The first trained model 122 is a model trained by machine learning and outputs a progression of predicted values of the first amount of electric power supply in a case where input data are input. For example, input data to the first trained model 122 include at least one item out of weather forecast information, information about an environment around the photovoltaic power generation equipment 52, and information about the photovoltaic power generation equipment 52. For example, the weather forecast information includes at least one item out of sunrise, sunset, a temperature progression, a progression of amounts of solar radiation, and a progression of amounts of cloud. The weather forecast information includes at least information about a region where the photovoltaic power generation equipment 52 is provided. For example, the information about the environment of the photovoltaic power generation equipment 52 is three-dimensional data of objects (such as a building and a tree) around a photovoltaic panel included in the photovoltaic power generation equipment 52. The information about the photovoltaic power generation equipment 52 includes at least one item out of electric power generation efficiency of the photovoltaic power generation equipment 52, a configuration of the photovoltaic power generation equipment 52, a manufacturer and a model number of the photovoltaic panel included in the photovoltaic power generation equipment 52, and information indicating whether the photovoltaic power generation equipment 52 is movable. The information about the environment around the photovoltaic power generation equipment 52 and the information about the photovoltaic power generation equipment 52 are previously held in the storage unit 140, and the advance prediction unit 120 can read and use the pieces of information. Further, for example, the advance prediction unit 120 may acquire the weather forecast information from a server of a weather information provider, or the like through a communication network. Note that the advance prediction unit 120 does not have to include the first trained model 122 and may predict the first amount of electric power supply by a determination based on a statistic or a rule base acquired in advance.

In a case where the source of electric power supply 54 includes a plurality of pieces of photovoltaic power generation equipment 52, a predicted value of the first amount of electric power supply is computed by using a predicted value of an amount of electric power supply from each piece of photovoltaic power generation equipment 52. Further, in a case where the source of electric power supply 54 includes electric power supply equipment other than the photovoltaic power generation equipment 52, a predicted value of the first amount of electric power supply is computed as the sum of predicted values of amounts of electric power supply furnished by each piece of electric power supply equipment. A predicted value of an amount of electric power supply from electric power supply equipment other than the photovoltaic power generation equipment 52 can be computed by using an existing method as appropriate. Further, a predicted value of an amount of electric power supply from electric power supply equipment based on energy other than renewable energy may be a predetermined value.

The acquisition unit 110 acquires a progression of predicted values of the first amount of electric power supply. Specifically, the acquisition unit 110 may acquire a progression of predicted values of the first amount of electric power supply for a predetermined period (such as 12 hours or 24 hours) from a current time at the time or may acquire a progression of all acquirable predicted values of the first amount of electric power supply. In the example in FIG. 3, the acquisition unit 110 can read and acquire a progression of predicted values of the first amount of electric power supply from the storage unit 140. Alternatively, the acquisition unit 110 may acquire a progression of predicted values of the first amount of electric power supply directly from the advance prediction unit 120.

The advance prediction unit 120 also predicts an amount of electric power demand at the supply target 50 and generates a progression of the predicted values. The advance prediction unit 120 can predict the amount of electric power demand at the supply target 50 for the same period as the prediction target period of the first amount of electric power supply at a timing of predicting the first amount of electric power supply. The advance prediction unit 120 causes the storage unit 140 to hold the generated progression of predicted values of the amount of electric power demand. For example, the advance prediction unit 120 further includes a second trained model 124. The second trained model 124 is a model trained by machine learning and outputs a progression of predicted values of the amount of electric power demand in a case where input data are input. For example, input data to the second trained model 124 may include at least one item out of a temperature progression, information indicating whether a day being a prediction target is a holiday, and information indicating operating status of the supply target 50. For example, the information indicating operating status of the supply target 50 is information indicating an amount of production of a product, the number of persons at work, and business hours.

The acquisition unit 110 acquires a progression of predicted values of an amount of electric power demand at the supply target 50. Specifically, the acquisition unit 110 may acquire a progression of predicted values of the first amount of electric power demand for a predetermined period (such as 12 hours or 24 hours) from a current time at the time or may acquire a progression of all acquirable predicted values of the amount of electric power demand. In the example in FIG. 3, the acquisition unit 110 may read and acquire a progression of predicted values of the amount of electric power demand from the storage unit 140. Alternatively, the acquisition unit 110 may acquire a progression of predicted values of the amount of electric power demand directly from the advance prediction unit 120.

Note that the prediction apparatus 10 may not include the advance prediction unit 120. In that case, a progression of predicted values of the first amount of electric power supply and a progression of predicted values of the amount of electric power demand may be generated by an apparatus other than the prediction apparatus 10. Each of the generated progressions of predicted values is held in a storage unit accessible from the acquisition unit 110, and the acquisition unit 110 can read and acquire the progressions. Alternatively, the acquisition unit 110 may acquire each progression of predicted values directly from an apparatus generating the progression. An apparatus generating a progression of predicted values of the first amount of electric power supply and an apparatus generating a progression of predicted values of the amount of electric power demand may be the same apparatus or separate apparatuses.

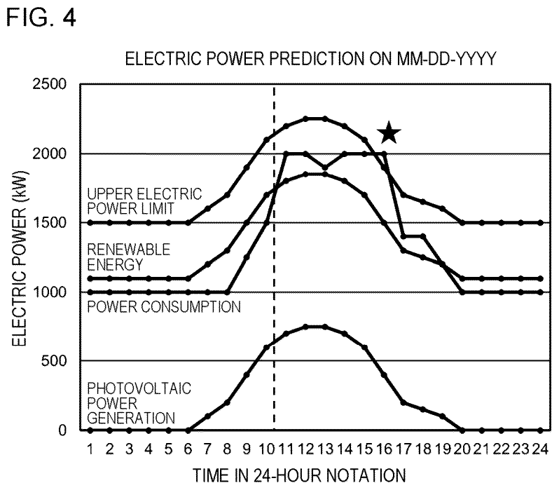

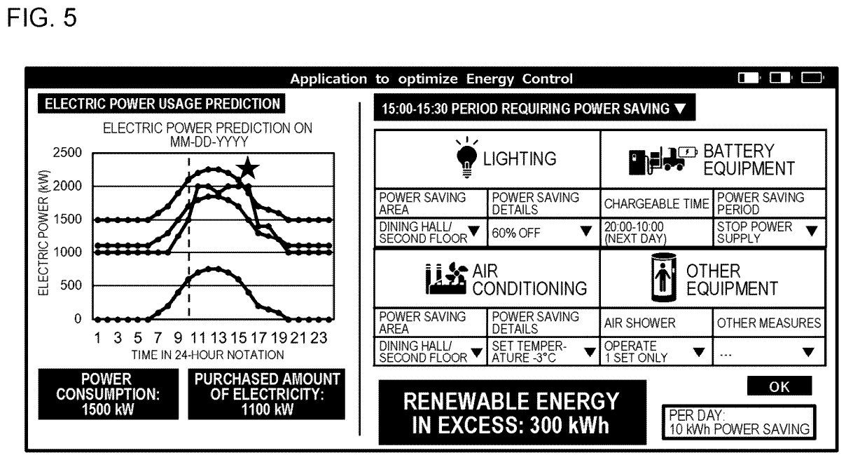

FIG. 4 is a diagram illustrating an example of a graph generated by the output unit 150. Further, FIG. 5 is a diagram illustrating an example of an image displayed based on notification information from the output unit 150. FIG. 4 corresponds to an enlarged view of a graph displayed on the left side in FIG. 5. The output unit 150 outputs at least one type of information out of notification information and control information, based on a comparison result between a predicted value of the first amount of electric power supply and a predicted value of the amount of electric power demand at the supply target 50 acquired by the acquisition unit 110. Control information is information for controlling at least one of an amount of electric power supply to the supply target 50 and the amount of electric power demand. As will be illustrated later, in a case where a predicted value of the first amount of electric power supply is modified or re-predicted, the output unit 150 outputs at least one type of information out of notification information and control information, based on a comparison result between the modified or re-predicted predicted value of the first amount of electric power supply and a predicted value of the amount of electric power demand at the supply target 50.

The output unit 150 may generate notification information as illustrated in FIG. 5 by using a progression of predicted values of the first amount of electric power supply and a progression of predicted values of the amount of electric power demand acquired by the acquisition unit 110. For example, the notification information is image data for causing a display to display an image. Without being limited to the example in FIG. 5, the notification information may be voice information or a signal for causing a light-emitting apparatus to blink.

The graph in FIG. 4 illustrates progressions of electric power supply and power consumption that are related to the supply target 50. “PHOTOVOLTAIC POWER GENERATION” in the graph indicates the first amount of electric power supply. Note that in the example in FIG. 4, the source of electric power supply 54 is assumed to include one or more pieces of the photovoltaic power generation equipment 52. “UPPER ELECTRIC POWER LIMIT” indicates a progression of electric power usable by the supply target 50 on the assumption that electric power usable within a basic scope of a contract with an electric power company is used to an upper limit. In other words, in a case where the amount of electric power demand exceeds the line, an additional charge or the like is incurred, and electric power becomes high in cost. The upper limit of electric power usable within the basic scope of the contract with the electric power company is a predetermined value. For example, “UPPER ELECTRIC POWER LIMIT” is acquired by adding the upper limit of electric power usable within the basic scope of the contract with the electric power company and an amount of supply acquired from another supplier by electricity purchase or the like to the first amount of electric power supply. Further, “RENEWABLE ENERGY” indicates an amount of electric power supply based on renewable energy to the supply target 50. Electric power supplied from a supply source other than the source of electric power supply 54 may include electric power of renewable energy origin. The sum of an amount of such electric power supply of renewable energy origin and an amount of electric power supply from the photovoltaic power generation equipment 52 corresponds to “RENEWABLE ENERGY.” In a case where the first amount of electric power supply includes an amount of electric power supply not of renewable energy origin, an amount of electric power of renewable energy origin can be computed by subtracting the amount of electric power supply not of renewable energy origin from the first amount of electric power supply. Alternatively, an amount of electric power supply of renewable energy origin may be computed by adding, out of an amount of electric power supply to the supply target 50, amounts of electric power supply furnished by pieces of electric power generation equipment generating electric power from renewable energy, such as the photovoltaic power generation equipment 52.

Note that electric power supplied from a supply source other than the source of electric power supply 54 may include electric power related to so-called electricity wheeled for self-use or an off-site PPA in addition to electric power generated by an electric power company. Note that as described above, electric power supply equipment related to electricity wheeled for self-use or an off-site PPA may be included in the source of electric power supply 54. Specifically, in a case where the supply target 50 receives electric power supply from a plurality of pieces of electric power supply equipment related to electricity wheeled for self-use or an off-site PPA, part of the plurality of pieces of electric power supply equipment may be included in the source of electric power supply 54, and the remaining part may not be included in the source of electric power supply 54.

“POWER CONSUMPTION” indicates the amount of electric power demand at the supply target 50. A broken line in FIG. 4 indicates a current time. In each line on the graph, a region on the left side of the broken line indicates actual values at the supply target 50, and a region on the right side indicates predicted values.

Power consumption at a current time and an amount of electric power supply from a supply source other than the source of electric power supply 54 (“PURCHASED AMOUNT OF ELECTRICITY”) are displayed on the left side in FIG. 5 in addition to a graph. The difference between a usage target of renewable energy and the amount of electric power demand is also indicated on the right side in FIG. 5. By such visualization, a user can recognize status and expectation of a supply-demand balance of electric power.

Further, a period determined to require power saving as a result of comparing a predicted value of the first amount of electric power supply with a predicted value of the amount of electric power demand is indicated on the right side in FIG. 5 as “PERIOD REQUIRING POWER SAVING.” For example, the output unit 150 determines a period in which a predicted value of the amount of electric power demand exceeds the upper electric power limit described above as a period requiring power saving. In the graph on the left side in FIG. 5, a position related to the period is marked with a star. Further, a detailed proposal related to control for decreasing the amount of electric power demand is provided on the right side in FIG. 5. For example, decreasing an amount of lighting in part of an area, stopping a power source for charging a battery for a predetermined period, decreasing a set temperature for heating in part of an area, stopping operation of part of a plurality of pieces of equipment, and the like are provided. Further, an amount of power saving achieved by the controls (the setting changes) is also displayed. A user selects (by clicking or touching) an “OK” button displayed on the screen as an approval operation. Then, control information is output from the output unit 150, and the control displayed on the screen is executed. In a case where a period determined to require power saving does not exist, the output unit 150 may output notification information for indicating a message such as “NO PROBLEM WITH BALANCE.” Note that the output unit 150 may automatically output control information without accepting an approval operation.

Without being particularly limited, for example, control information is information for controlling at least one item out of lighting, an air conditioner, a refrigerator, a freezer, a boiler, a water heater, sanitary equipment, a compressor, wastewater treatment equipment, and water supply and sewerage equipment. Further, control information may be information for controlling electrical power reception-transformation equipment, such as shutting off an unnecessary transformer, or may be information for controlling equipment for recovery and use of exhaust heat.

The output unit 150 can determine contents of notification information and control information that are to be output, based on a result of comparing a predicted value of the first amount of electric power supply with a predicted value of the amount of electric power demand. For example, the output unit 150 computes a required amount of decrease in power consumption by subtracting a predicted value of the amount of electric power demand from a predicted value of the first amount of electric power supply. On the other hand, the storage unit 140 previously holds reference information in which an amount of decrease is associated with at least one type of information out of notification information and control information. The storage unit 140 determines at least one type of information out of notification information and control information that are related to the computed amount of decrease in the reference information as information that needs to be output.

For example, at a timing of acquisition of a progression of predicted values of the first amount of electric power supply and a progression of predicted values of the amount of electric power demand by the acquisition unit 110, the output unit 150 determines a period requiring power saving and further determines at least one type of information out of notification information and control information that need output, by using the acquired progressions of predicted values. Alternatively, the output unit 150 may determine a period requiring power saving and determine at least one type of information out of notification information and control information that need output on a predetermined cycle or at a predetermined timing. Furthermore, the output unit 150 may determine a period requiring power saving at a timing of modification or re-prediction of the progression of predicted values of the first amount of electric power supply and determine at least one type of information out of notification information and control information that need to be output. In a case where determining at least one type of information out of notification information and control information that need output, the output unit 150 outputs the determined information.

### Predetermined Condition

In a case where the predetermined condition is satisfied, the prediction unit 130 in the prediction apparatus 10 according to the present example embodiment modifies or re-predicts a progression of predicted values of the first amount of electric power supply by using an image acquired by capturing an image of the sky. In other words, the prediction unit 130 modifies or re-predicts a progression of predicted values of the first amount of electric power supply with satisfaction of the predetermined condition as a trigger. In a case where the predetermined condition is not satisfied, the prediction unit 130 does not modify or re-predict a progression of predicted values of the first amount of electric power supply. Accordingly, the processing load is reduced compared with a case of continuously performing prediction using an image. Examples of the predetermined condition will be described below. The predetermined condition includes a plurality of conditions, and for example, in a case where at least one of the plurality of conditions is satisfied, the predetermined condition is determined to be satisfied. For example, in a case where at least one of a plurality of conditions described below is satisfied, the prediction unit 130 modifies or re-predicts a progression of predicted values of the first amount of electric power supply by using an image. However, the predetermined condition is not limited to the following examples and may be another condition. The prediction unit 130 modifies or re-predicts a progression of predicted values of the first amount of electric power supply at least in a case where a state of the predetermined condition not being satisfied changes to a state of being satisfied. The prediction unit 130 may modify or re-predict a progression of predicted values of the first amount of electric power supply only in a case where the state of the predetermined condition being not satisfied changes to the state of being satisfied or may further modify or re-predict the progression of predicted values of the first amount of electric power supply while the predetermined condition is satisfied.

Condition Related to Predicted Value The predetermined condition may include a condition related to a predicted value of the first amount of electric power supply. For example, the predetermined condition includes at least one of a condition (1) and a condition (2) that are described below.

The condition (1) is that the ratio of a predicted value of an amount of electric power demand at a supply target to a predicted value of the first amount of electric power supply satisfies a predetermined first criterion. The prediction unit 130 computes a value of “a predicted value of the amount of electric power demand at a supply target/a predicted value of the first amount of electric power supply” at each time by using a progression of predicted values of the first amount of electric power supply and a progression of predicted values of the amount of electric power demand acquired by the acquisition unit 110. Then, the prediction unit 130 determines a timing at which the computed value exceeds a predetermined criterial value S₁, that is, a time when the computed value changes from a value equal to or less than the criterial value S₁ to a value exceeding the criterial value S₁. For example, the criterial value Si is equal to or greater than 0.8 and equal to or less than 1.2. The condition (1) is satisfied at the determined time. When the determined time arrives, the prediction unit 130 acquires an image of the sky and modifies or re-predicts a progression of predicted values of the first amount of electric power supply. A more accurate predicted value of the first amount of electric power supply can be acquired prior to a timing at which the amount of electric power demand needs to be held down. By extension, appropriate measures can be taken.

The condition (2) is that the difference between an actual value and a predicted value of the first amount of electric power supply satisfies a predetermined second criterion. The prediction unit 130 compares a predicted value of the first amount of electric power supply acquired by the acquisition unit 110 for a current time with a current actual value of the first amount of electric power supply (an actual value). The actual value acquisition unit 160 in the prediction apparatus 10 may acquire an actual value of the first amount of electric power supply of the source of electric power supply 54 from the source of electric power supply 54 on a predetermined cycle (for example, every minute). Comparison between a predicted value and an actual value of the first amount of electric power supply is performed every time an actual value is acquired. The prediction unit 130 computes the magnitude of the difference between a predicted value of the first amount of electric power supply and an actual value of the first amount of electric power supply. The prediction unit 130 determines whether the computed magnitude of the difference is equal to or greater than a predetermined criterial value S₂. In a case where the computed magnitude of the difference is equal to or greater than the predetermined criterial value S₂, the condition (2) is determined to be satisfied. On the other hand, in a case where the computed magnitude of the difference is not equal to or greater than the predetermined criterial value S₂, the condition (2) is determined to be not satisfied. In a case where the condition (2) is determined to be satisfied, the prediction unit 130 acquires an image of the sky and modifies or re-predicts a progression of predicted values of the first amount of electric power supply. Thus, in a case where the precision of a predicted value falls into an insufficient state, a more accurate predicted value of the first amount of electric power supply can be acquired.

In addition, as a condition related to a predicted value of the first amount of electric power supply, the predetermined condition may include a condition that is satisfied at the timing when the ratio of a predicted value of the amount of electric power demand at the supply target 50 to a predicted value of the upper electric power limit described above satisfies the predetermined first criterion.

### Condition Related to Electric Power System Grid

The predetermined condition may include a condition related to at least one item out of electric power supply from the electric power system grid 60 to the supply target 50 and electric power supply from the source of electric power supply 54 to the electric power system grid 60. For example, the predetermined condition includes at least one of a condition (3) and a condition (4).

The condition (3) is reception of information indicating that a second amount of electric power supply being an amount of electric power supply from the electric power system grid 60 to the supply target 50 needs to be changed. For example, the information indicating that the second amount of electric power supply needs to be changed is transmitted from an electric power company and is acquired by the change information acquisition unit 170 through a communication network. For example, in a case where an amount of demand for electric power in the electric power system grid 60 approaches or is expected to approach an upper supply limit, the electric power company transmits information requesting an electric power user to reduce an amount of electric power supply from the electric power system grid 60 to the supply target 50, that is, information indicating that the second amount of electric power supply needs to be changed. For example, the information indicating that the second amount of electric power supply needs to be changed is a so-called “downward demand response (DR).” In a case where such information is received, an amount of electric power demand at the supply target 50 needs to be held down. Note that the second amount of electric power supply may mean an amount of electric power supply from a supply source other than the source of electric power supply 54 or may mean an amount of electric power supply from electric power generation equipment in an electric power company. In a case where the change information acquisition unit 170 receives information indicating that the second amount of electric power supply needs to be changed, the prediction unit 130 determines that the condition (3) is satisfied, then acquires an image of the sky, and modifies or re-predicts a progression of predicted values of the first amount of electric power supply. Thus, appropriate power saving can be performed based on a more accurate predicted value of the first amount of electric power supply.

The condition (4) is reception of information indicating that a third amount of electric power supply being an amount of electric power supply from the source of electric power supply 54 to the electric power system grid 60 needs to be changed. For example, the information indicating that the third amount of electric power supply needs to be changed is transmitted from an electric power company and is acquired by the change information acquisition unit 170 through a communication network. For example, in a case where an amount of electric power supply in the electric power system grid 60 considerably exceeds or is expected to considerably exceed an amount of demand, the electric power company transmits information requesting an electric power user to reduce an amount of electric power supply from the source of electric power supply 54 to the electric power system grid 60, that is, information indicating that the third amount of electric power supply needs to be changed. For example, the information indicating that the third amount of electric power supply needs to be changed is a so-called “upward DR.” In a case where such information is received, an amount of electric power demand at the supply target 50 needs to be increased. In a case where the change information acquisition unit 170 receives information indicating that the third amount of electric power supply needs to be changed, the prediction unit 130 determines that the condition (4) is satisfied, then acquires an image of the sky, and modifies or re-predicts a progression of predicted values of the first amount of electric power supply. Thus, an amount of electric power usage can be appropriately adjusted based on a more accurate predicted value of the first amount of electric power supply.

### Condition Related to Renewable Energy

The predetermined condition may include a condition related to electric power supply based on renewable energy to the supply target 50. For example, the predetermined condition includes a condition (5).

The condition (5) is that the difference between an amount of electric power supply based on renewable energy to the supply target 50 and an amount of electric power demand at the supply target 50 or a cumulative value of the difference satisfies a third criterion. An electric power user preferably causes power consumption to be covered by as much electric power of renewable energy origin as possible. The prediction unit 130 computes a progression of amounts of electric power supply of renewable energy origin in an amount of electric power supply to the supply target 50. An amount of electric power supply of renewable energy origin has been described in relation to FIG. 4. The amount of electric power demand at the supply target 50 preferably agrees with the amount of electric power supply of renewable energy origin as much as possible. An amount of electric power supply based on renewable energy at least includes an amount of electric power supply from the photovoltaic power generation equipment 52 in the source of electric power supply 54. The amount of electric power supply based on renewable energy may further include an amount of electric power supply from electric power generation equipment based on another type of renewable energy included in the source of electric power supply 54. Further, the amount of electric power supply based on renewable energy may further include an amount of electric power supply of renewable energy origin purchased from another business operator. Further, the amount of electric power supply based on renewable energy may include an amount of electric power supply from photovoltaic power generation equipment 52 in a location distant from the supply target 50. The prediction unit 130 can compute a progression of amounts of electric power supply based on renewable energy to the supply target 50 by acquiring and totaling progressions of the respective amounts of electric power supply.

The prediction unit 130 computes the magnitude of the difference between a computed amount of electric power supply based on renewable energy and the amount of electric power demand at the supply target 50 every time an actual value of each amount is acquired. Then, the prediction unit 130 determines whether the computed magnitude of the difference is equal to or greater than a predetermined criterial value S₃. In a case where the computed magnitude of the difference is equal to or greater than the predetermined criterial value S₃, the condition (5) is satisfied. In a case where the computed magnitude of the difference is equal to or greater than the predetermined criterial value S₃, the prediction unit 130 acquires an image of the sky and modifies or re-predicts a progression of predicted values of the first amount of electric power supply. Thus, power consumption can be appropriately adjusted based on a more accurate predicted value of the first amount of electric power supply.

Alternatively, the prediction unit 130 computes the difference by subtracting one of an amount of electric power supply based on renewable energy and the amount of electric power demand at the supply target 50 from the other. Then, the prediction unit 130 further computes a cumulative value of the difference for a predetermined period with a current time as an ending point. Then, the prediction unit 130 determines whether the absolute value of the computed cumulative value is equal to or greater than a predetermined criterial value S₄. In a case where the absolute value of the computed cumulative value is equal to or greater than the predetermined criterial value S₄, the condition (5) is satisfied. In a case where the absolute value of the computed cumulative value is equal to or greater than the predetermined criterial value S₄, the prediction unit 130 acquires an image of the sky and modifies or re-predicts a progression of predicted values of the first amount of electric power supply. Thus, power consumption can be appropriately adjusted based on a more accurate predicted value of the first amount of electric power supply.

### Prediction

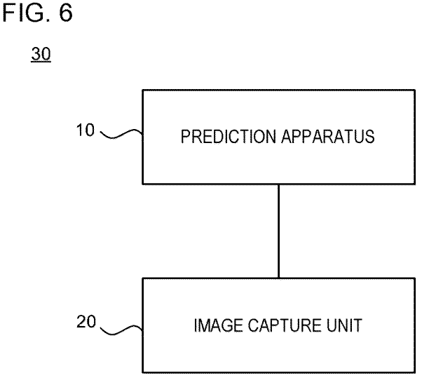

FIG. 6 is a diagram illustrating a configuration of a prediction system 30 according to the present example embodiment. The prediction system 30 includes the prediction apparatus 10 and an image capture unit 20 that captures an image of the sky around the photovoltaic power generation equipment 52. For example, the image capture unit 20 is a camera. The image capture unit 20 may include a fisheye lens. Further, the image capture unit 20 may have a variable image capture direction. The image capture unit 20 is preferably provided close to the photovoltaic power generation equipment 52. For example, the distance between the image capture unit 20 and the photovoltaic panel in the photovoltaic power generation equipment 52 is preferably equal to or less than 100 m. The prediction apparatus 10 is connected to the image capture unit 20 in a wired or wireless manner. In a case where the predetermined condition is determined to be satisfied in the prediction apparatus 10, the image capture unit 20 captures an image of the sky around the photovoltaic power generation equipment 52. Specifically, in a case where the prediction unit 130 determines that the predetermined condition is satisfied, the image acquisition unit 180 outputs a control signal for causing the image capture unit 20 to capture an image of the sky. In a case where receiving the control signal from the image acquisition unit 180, the image capture unit 20 captures an image of the sky around the photovoltaic power generation equipment 52 at that point in time. In a case where an image of the sky is captured by the image capture unit 20, the image acquisition unit 180 acquires the image from the image capture unit 20. Further, the prediction unit 130 modifies or re-predicts a progression of predicted values of the first amount of electric power supply by using the image acquired by the image acquisition unit 180.

While an image capture range of an image of the sky around the photovoltaic power generation equipment 52 is not particularly limited, for example, an image of the sky preferably includes the sky immediately above the photovoltaic power generation equipment 52. Further, an image of the sky preferably includes the sky in the direction of the sun. Further, in a case where the direction of the image capture unit 20 is variable, the image acquisition unit 180 may acquire wind information of a region where the photovoltaic power generation equipment 52 is positioned from a server of a weather information provider or the like through a communication network and control the direction of the image capture unit 20 in such a way that an image of the sky in a windward direction viewed from the photovoltaic power generation equipment 52 is captured.

The prediction unit 130 modifies or re-predicts a progression of predicted values of the first amount of electric power supply by using an image of the sky around the photovoltaic power generation equipment 52. Further, the prediction unit 130 may modify or re-predict a progression of predicted values of the first amount of electric power supply by further using a date and time or information about the position of the sun. In a case where a date and time is used, the prediction unit 130 can determine the position (direction) of the sun viewed from the photovoltaic power generation equipment 52 by using the date and time and known positional information of the photovoltaic power generation equipment 52. The prediction unit 130 may acquire information indicating the position of the sun from a server of a weather information provider or the like through a communication network. Since electric power generation efficiency of the photovoltaic power generation equipment 52 may vary with the direction of the sun, and an effect of a building or the like around the photovoltaic power generation equipment 52 varies with the direction, prediction precision can be improved by using a date and time or information about the position of the sun.

The prediction unit 130 may modify or re-predict a progression of predicted values of the first amount of electric power supply by further using at least one item out of wind information and the temperature. For example, wind information includes information indicating the direction and the intensity of the wind. Wind information may be an actually measured value or a predicted value. Movement of a cloud blocking the sunlight varies depending on the direction and the intensity of the wind. Further, the electric power generation efficiency of the photovoltaic power generation equipment 52 varies depending on the temperature. Accordingly, prediction precision can be improved by using at least one item out of wind information and the temperature.

Further, in a case where an image of the sky includes an image of the windward sky viewed from the photovoltaic power generation equipment 52, the prediction unit 130 preferably modifies or re-predicts a progression of predicted values of the first amount of electric power supply by using wind information. Thus, a prediction taking a state change of a cloud caused by the wind into account can be performed.

For example, the prediction unit 130 includes a third trained model 132. The third trained model 132 is a model trained by machine learning and outputs a progression of predicted values of the first amount of electric power supply in a case where input data are input. The prediction unit 130 substitutes a progression of predicted values of the first amount of electric power supply output from the third trained model 132 for a progression of predicted values of the first amount of electric power supply acquired by the acquisition unit 110 in a related period. Input data to the third trained model 132 include at least an image acquired by capturing an image of the sky around the photovoltaic power generation equipment 52. Further, input data to the third trained model 132 may further include at least one item out of a date and time, information about the position of the sun, wind information, and the temperature. Input data to the third trained model 132 may or may not further include at least part of a progression of predicted values of the first amount of electric power supply acquired by the acquisition unit 110. The third trained model 132 outputs a progression of predicted values of the first amount of electric power supply in a predetermined period on the basis of a current time. For example, the starting point of the predetermined period may be a current time or a time after a lapse of a time Tₛ from the current time. For example, Tₛ is equal to or greater than 5 minutes and equal to or less than 45 minutes. For example, the ending point of the predetermined period is a time after a lapse of a time Tₑ from the current time. For example, Tₑ is equal to or greater than 30 minutes and equal to or less than 3 hours. In addition, the predetermined period may be a period determined to require demand suppression or the like, such as a period in which the difference between an amount of electric power supply predicted by the first trained model and an amount of electric power demand predicted by the second trained model exceeds a threshold value.

The output unit 150 generates and outputs at least one type of information out of notification information and control information by using the thus updated predicted value of the first amount of electric power supply. Accordingly, more appropriate notification and control can be performed on electric power usage.

A hardware configuration of the prediction apparatus 10 will be described below. Each functional unit in the prediction apparatus 10 may be provided by hardware (such as a hardwired electronic circuit) providing the functional unit or may be provided by a combination of hardware and software (such as an electronic circuit and a program controlling the circuit). The case of each functional unit in the prediction apparatus 10 being provided by a combination of hardware and software will be further described below.

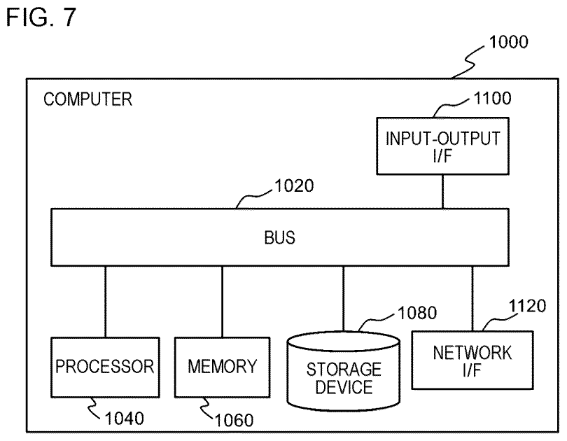

FIG. 7 is a diagram illustrating a computer 1000 for achieving the prediction apparatus 10. The computer 1000 is any computer. For example, the computer 1000 is a system-on-chip (SoC), a personal computer (PC), a server machine, a tablet terminal, or a smartphone. The computer 1000 may be a dedicated computer designed for achieving the prediction apparatus 10 or may be a general-purpose computer.

The computer 1000 includes a bus 1020, a processor 1040, a memory 1060, a storage device 1080, an input-output interface 1100, and a network interface 1120. The bus 1020 is a data transmission channel for the processor 1040, the memory 1060, the storage device 1080, the input-output interface 1100, and the network interface 1120 to transmit and receive data to and from each other. Note that the method for interconnecting the processor 1040 and other components is not limited to a bus connection. Examples of the processor 1040 include various processors such as a central processing unit (CPU), a graphics processing unit (GPU), and a field-programmable gate array (FPGA). The memory 1060 is a main storage provided by a random-access memory (RAM) or the like. The storage device 1080 is an auxiliary storage provided by a hard disk, a solid-state drive (SSD), a memory card, a read-only memory (ROM), or the like.

The input-output interface 1100 is an interface for connecting the computer 1000 to input/output devices. For example, the input-output interface 1100 is connected to an input apparatus such as a keyboard, and an output apparatus such as a display.

The network interface 1120 is an interface for connecting the computer 1000 to a network. Examples of the communication network include a local area network (LAN) and a wide area network (WAN). The method for connecting the network interface 1120 to the network may be a wireless connection or a wired connection.

The storage device 1080 stores program modules for providing the functions of the prediction apparatus 10. By the processor 1040 reading each program module into the memory 1060 and executing the program module, each function related to the program module is provided. Further, in a case where the storage unit 140 is provided inside the prediction apparatus 10, for example, the storage unit 140 is provided by using the storage device 1080.

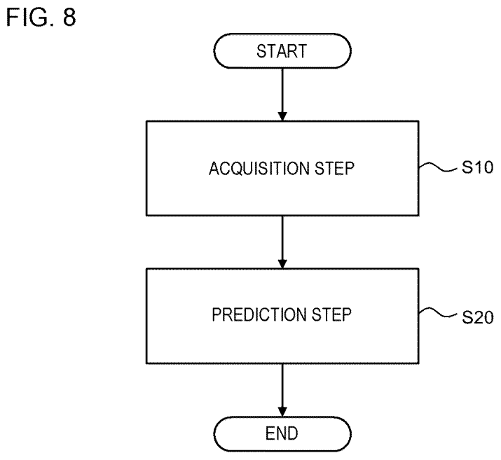

FIG. 8 is a flowchart illustrating an overview of a prediction method executed by the prediction apparatus 10 according to the present example embodiment. One or more computers perform an acquisition step S10 and a prediction step S20 in the prediction method according to the present example embodiment. In the acquisition step S10, a progression of predicted values of the first amount of electric power supply is acquired. The first amount of electric power supply is an amount of electric power supply to the supply target 50 from the source of electric power supply 54 including at least one piece of photovoltaic power generation equipment 52. In the prediction step S20, the progression of predicted values of the first amount of electric power supply is modified or re-predicted in a case where the predetermined condition is satisfied. The modification or re-prediction is performed by using an image acquired by capturing an image of the sky around the photovoltaic power generation equipment 52.

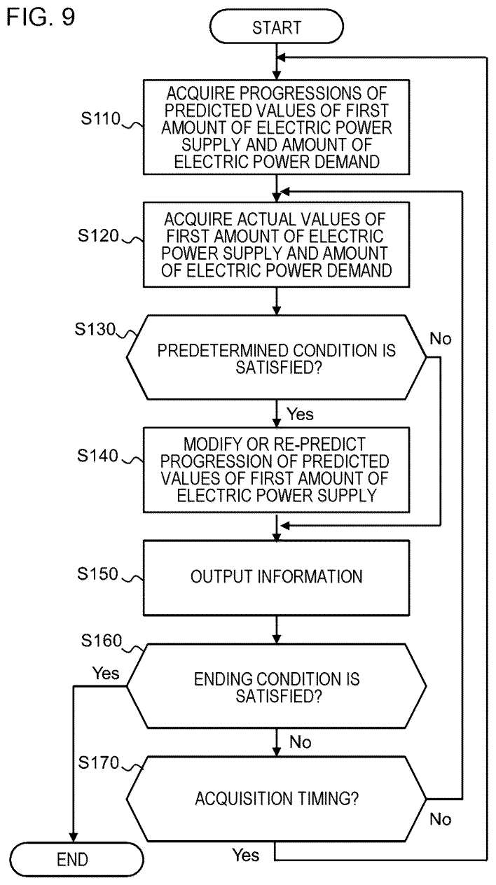

FIG. 9 is a flowchart illustrating a flow of the prediction method according to the present example embodiment. In a case where processing in the prediction apparatus 10 is started, the acquisition unit 110 acquires a progression of predicted values of the first amount of electric power supply and a progression of predicted values of an amount of electric power demand (S110). In a case where the prediction apparatus 10 includes the advance prediction unit 120, the advance prediction unit 120 generates a progression of predicted values of the first amount of electric power supply and a progression of predicted values of the amount of electric power demand, and the acquisition unit 110 acquires the progressions, in S110.

Next, in S120, the prediction unit 130 acquires latest actual values of the first amount of electric power supply and the amount of electric power demand. Then, in S130, the prediction unit 130 determines whether the predetermined condition is satisfied. In a case where the predetermined condition is satisfied (Yes in S130), the prediction unit 130 updates the progression of predicted values of the first amount of electric power supply (S140). Next, in S150, the output unit 150 determines and outputs information that needs to be output. In a case where the predetermined condition is not satisfied (No in S130), S140 is not performed, and S150 is performed. Subsequently to S150, whether an ending condition is satisfied is determined (S160), and in a case where the ending condition is satisfied (Yes in S160), the processing in the prediction apparatus 10 is ended. For example, a case of the ending condition being satisfied is a case of an operation for ending the processing in the prediction apparatus 10 being performed on the prediction apparatus 10.

In a case where the ending condition is not satisfied (No in S160), whether a timing for the acquisition unit 110 to acquire a new progression of predicted values of the first amount of electric power supply and a new progression of predicted values of the amount of electric power demand has arrived is determined (S170). For example, when a predetermined time elapses since the previous acquisition of the progressions by the acquisition unit 110 or at a predetermined time, a timing for the acquisition unit 110 to acquire a new progression of predicted values of the first amount of electric power supply and a new progression of predicted values of the amount of electric power demand is determined to have arrived. In a case where a timing for the acquisition unit 110 to acquire a new progression of predicted values of the first amount of electric power supply and a new progression of predicted values of the amount of electric power demand is determined to have arrived (Yes in S170), the processing returns to S110. In a case where a timing for the acquisition unit 110 to acquire a new progression of predicted values of the first amount of electric power supply and a new progression of predicted values of the amount of electric power demand is not determined have arrived (No in S170), the processing returns to S120.

As described above, the prediction unit 130 according to the present example embodiment modifies or re-predicts the progression of predicted values of the first amount of electric power supply by using an image of the sky in a case where the predetermined condition is satisfied. Accordingly, high-precision prediction based on an image of the sky is performed only in a case where necessary, and therefore, the processing load can be reduced.

While the example embodiments of the present invention have been described above with reference to the drawings, the example embodiments are exemplifications of the present invention, and various configurations other than those described above may also be employed.

Further, while a plurality of steps (processing) are described in a sequential order in each of a plurality of flowcharts used in the aforementioned description, the execution order of steps executed in each example embodiment is not limited to the order of description. The order of the illustrated steps may be modified without affecting the contents in each example embodiment. Further, the aforementioned example embodiments may be combined without contradicting each other.

The whole or part of the example embodiments disclosed above may also be described as, but not limited to, the following supplementary notes.

1-1. A prediction apparatus including:

an acquisition unit that acquires a progression of one or more predicted values of a first amount of electric power supply from a source of electric power supply including at least one piece of photovoltaic power generation equipment to a supply target; and

a prediction unit that, in a case where a predetermined condition is satisfied, modifies or re-predicts the progression of one or more predicted values of the first amount of electric power supply by using an image acquired by capturing an image of a sky around the photovoltaic power generation equipment.

1-2. The prediction apparatus according to supplementary note 1-1, in which

the predetermined condition includes at least one of a condition (1) and a condition (2),

the condition (1) is that a ratio of a predicted value of an amount of electric power demand at the supply target to a predicted value of the first amount of electric power supply satisfies a predetermined first criterion, and

the condition (2) is that a difference between an actual value and a predicted value of the first amount of electric power supply satisfies a predetermined second criterion.

1-3. The prediction apparatus according to supplementary note 1-1 or 1-2, in which

the predetermined condition includes a condition related to at least one item out of electric power supply from an electric power system grid to the supply target and electric power supply from the source of electric power supply to the electric power system grid.

1-4. The prediction apparatus according to supplementary note 1-3, in which

the predetermined condition includes at least one of a condition (3) and a condition (4),

the condition (3) is reception of information indicating that a second amount of electric power supply being an amount of electric power supply from the electric power system grid to the supply target needs to be changed, and

the condition (4) is reception of information indicating that a third amount of electric power supply being an amount of electric power supply from the source of electric power supply to the electric power system grid needs to be changed.

1-5. The prediction apparatus according to any one of supplementary notes 1-1 to 1-4, in which

the predetermined condition includes a condition related to electric power supply based on renewable energy to the supply target.

1-6. The prediction apparatus according to supplementary note 1-5, in which

the predetermined condition includes a condition (5), and

the condition (5) is that a difference between an amount of electric power supply based on renewable energy to the supply target and an amount of electric power demand at the supply target, or a cumulative value of the difference satisfies a third criterion.

1-7. The prediction apparatus according to any one of supplementary notes 1-1 to 1-6, in which

the prediction unit modifies or re-predicts the progression of one or more predicted

values of the first amount of electric power supply by further using a date and time or information about a position of the sun.

1-8. The prediction apparatus according to any one of supplementary notes 1-1 to 1-7, in which

the prediction unit modifies or re-predicts the progression of one or more predicted values of the first amount of electric power supply by further using at least one item out of wind information and temperature.

1-9. The prediction apparatus according to any one of supplementary notes 1-1 to 1-8, in which

the prediction unit modifies or re-predicts the progression of one or more predicted values of the first amount of electric power supply by using wind information, and

the image includes an image of a windward sky viewed from the photovoltaic power generation equipment.

1-10. The prediction apparatus according to any one of supplementary notes 1-1 to 1-9, further including

an output unit that outputs at least one type of information out of notification information and control information, based on a comparison result between a modified or re-predicted predicted value of the first amount of electric power supply and a predicted value of an amount of electric power demand at the supply target, in which

the control information is information for controlling at least one of an amount of electric power supply to the supply target and the amount of electric power demand.

2-1. A prediction system including:

the prediction apparatus according to any one of supplementary notes 1-1 to 1-10; and

an image capture unit that captures the image of the sky around the photovoltaic power generation equipment in a case where the predetermined condition is determined to be satisfied in the prediction apparatus.

3-1. A prediction method including, by one or more computers:

acquiring a progression of one or more predicted values of a first amount of electric power supply from a source of electric power supply including at least one piece of photovoltaic power generation equipment to a supply target; and,

in a case where a predetermined condition is satisfied, modifying or re-predicting the progression of one or more predicted values of the first amount of electric power supply by using an image acquired by capturing an image of a sky around the photovoltaic power generation equipment.

3-2. The prediction method according to supplementary note 3-1, in which

the predetermined condition includes at least one of a condition (1) and a condition (2),

the condition (1) is that a ratio of a predicted value of an amount of electric power demand at the supply target to a predicted value of the first amount of electric power supply satisfies a predetermined first criterion, and

the condition (2) is that a difference between an actual value and a predicted value of the first amount of electric power supply satisfies a predetermined second criterion.

3-3. The prediction method according to supplementary note 3-1 or 3-2, in which

the predetermined condition includes a condition related to at least one item out of electric power supply from an electric power system grid to the supply target and electric power supply from the source of electric power supply to the electric power system grid.

3-4. The prediction method according to supplementary note 3-3, in which

the predetermined condition includes at least one of a condition (3) and a condition (4),

the condition (3) is reception of information indicating that a second amount of electric power supply being an amount of electric power supply from the electric power system grid to the supply target needs to be changed, and

the condition (4) is reception of information indicating that a third amount of electric power supply being an amount of electric power supply from the source of electric power supply to the electric power system grid needs to be changed.

3-5. The prediction method according to any one of supplementary notes 3-1 to 3-4, in which

the predetermined condition includes a condition related to electric power supply based on renewable energy to the supply target.

3-6. The prediction method according to supplementary note 3-5, in which

the predetermined condition includes a condition (5), and

the condition (5) is that a difference between an amount of electric power supply based on renewable energy to the supply target and an amount of electric power demand at the supply target, or a cumulative value of the difference satisfies a third criterion.

3-7. The prediction method according to any one of supplementary notes 3-1 to 3-6, further including, by the one or more computers,

modifying or re-predicting the progression of one or more predicted values of the first amount of electric power supply by further using a date and time or information about a position of the sun.

3-8. The prediction method according to any one of supplementary notes 3-1 to 3-7, further including, by the one or more computers,

modifying or re-predicting the progression of one or more predicted values of the first amount of electric power supply by further using at least one item out of wind information and temperature.

3-9. The prediction method according to any one of supplementary notes 3-1 to 3-8, further including, by the one or more computers,

modifying or re-predicting the progression of one or more predicted values of the first amount of electric power supply by using wind information, in which

the image includes an image of a windward sky viewed from the photovoltaic power generation equipment.

3-10. The prediction method according to any one of supplementary notes 3-1 to 3-9, further including, by the one or more computers,

outputting at least one type of information out of notification information and control information, based on a comparison result between a modified or re-predicted predicted value of the first amount of electric power supply and a predicted value of an amount of electric power demand at the supply target, in which

the control information is information for controlling at least one of an amount of electric power supply to the supply target and the amount of electric power demand.

4-1. A storage medium storing a program causing a computer to execute a prediction method including, by the computer:

acquiring a progression of one or more predicted values of a first amount of electric power supply from a source of electric power supply including at least one piece of photovoltaic power generation equipment to a supply target; and,

in a case where a predetermined condition is satisfied, modifying or re-predicting the progression of one or more predicted values of the first amount of electric power supply by using an image acquired by capturing an image of a sky around the photovoltaic power generation equipment.

4-2. The storage medium according to supplementary note 4-1, in which

the predetermined condition includes at least one of a condition (1) and a condition (2),

the condition (1) is that a ratio of a predicted value of an amount of electric power demand at the supply target to a predicted value of the first amount of electric power supply satisfies a predetermined first criterion, and

the condition (2) is that a difference between an actual value and a predicted value of the first amount of electric power supply satisfies a predetermined second criterion.

4-3. The storage medium according to supplementary note 4-1 or 4-2, in which

the predetermined condition includes a condition related to at least one item out of electric power supply from an electric power system grid to the supply target and electric power supply from the source of electric power supply to the electric power system grid.

4-4. The storage medium according to supplementary note 4-3, in which

the predetermined condition includes at least one of a condition (3) and a condition (4),

the condition (3) is reception of information indicating that a second amount of electric power supply being an amount of electric power supply from the electric power system grid to the supply target needs to be changed, and

the condition (4) is reception of information indicating that a third amount of electric power supply being an amount of electric power supply from the source of electric power supply to the electric power system grid needs to be changed.

4-5. The storage medium according to any one of supplementary notes 4-1 to 4-4, in which

the predetermined condition includes a condition related to electric power supply based on renewable energy to the supply target.

4-6. The storage medium according to supplementary note 4-5, in which

the predetermined condition includes a condition (5), and

the condition (5) is that a difference between an amount of electric power supply based on renewable energy to the supply target and an amount of electric power demand at the supply target, or a cumulative value of the difference satisfies a third criterion.

4-7. The storage medium according to any one of supplementary notes 4-1 to 4-6, in which,

in the prediction method, the computer further modifies or re-predicts the progression of one or more predicted values of the first amount of electric power supply by further using a date and time or information about a position of the sun.

4-8. The storage medium according to any one of supplementary notes 4-1 to 4-7, in which,

in the prediction method, the computer further modifies or re-predicts the progression of one or more predicted values of the first amount of electric power supply by further using at least one item out of wind information and temperature.

4-9 The storage medium according to any one of supplementary notes 4-1 to 4-8, in which,

in the prediction method, the computer further modifies or re-predicts the progression of one or more predicted values of the first amount of electric power supply by using wind information, and

the image includes an image of a windward sky viewed from the photovoltaic power generation equipment.

4-10. The storage medium according to any one of supplementary notes 4-1 to 4-9, in which,

in the prediction method, the computer further outputs at least one type of information out of notification information and control information, based on a comparison result between a modified or re-predicted predicted value of the first amount of electric power supply and a predicted value of an amount of electric power demand at the supply target, and

the control information is information for controlling at least one of an amount of electric power supply to the supply target and the amount of electric power demand.

5-1. A program causing a computer to execute a prediction method including, by the computer:

acquiring a progression of one or more predicted values of a first amount of electric power supply from a source of electric power supply including at least one piece of photovoltaic power generation equipment to a supply target; and,

in a case where a predetermined condition is satisfied, modifying or re-predicting the progression of one or more predicted values of the first amount of electric power supply by using an image acquired by capturing an image of a sky around the photovoltaic power generation equipment.

5-2. The program according to supplementary note 5-1, in which

the predetermined condition includes at least one of a condition (1) and a condition (2),

the condition (1) is that a ratio of a predicted value of an amount of electric power demand at the supply target to a predicted value of the first amount of electric power supply satisfies a predetermined first criterion, and

the condition (2) is that a difference between an actual value and a predicted value of the first amount of electric power supply satisfies a predetermined second criterion.

5-3. The program according to supplementary note 5-1 or 5-2, in which

the predetermined condition includes a condition related to at least one item out of electric power supply from an electric power system grid to the supply target and electric power supply from the source of electric power supply to the electric power system grid.

5-4. The program according to supplementary note 5-3, in which

the predetermined condition includes at least one of a condition (3) and a condition (4),

the condition (3) is reception of information indicating that a second amount of electric power supply being an amount of electric power supply from the electric power system grid to the supply target needs to be changed, and

the condition (4) is reception of information indicating that a third amount of electric power supply being an amount of electric power supply from the source of electric power supply to the electric power system grid needs to be changed.

5-5. The program according to any one of supplementary notes 5-1 to 5-4, in which

the predetermined condition includes a condition related to electric power supply based on renewable energy to the supply target.

5-6. The program according to supplementary note 5-5, in which

the predetermined condition includes a condition (5), and

the condition (5) is that a difference between an amount of electric power supply based on renewable energy to the supply target and an amount of electric power demand at the supply target, or a cumulative value of the difference satisfies a third criterion.

5-7. The program according to any one of supplementary notes 5-1 to 5-6, in which,

in the prediction method, the computer further modifies or re-predicts the progression of one or more predicted values of the first amount of electric power supply by further using a date and time or information about a position of the sun.

5-8. The program according to any one of supplementary notes 5-1 to 5-7, in which,

in the prediction method, the computer further modifies or re-predicts the progression of one or more predicted values of the first amount of electric power supply by further using at least one item out of wind information and temperature.

5-9. The program according to any one of supplementary notes 5-1 to 5-8, in which,

in the prediction method, the computer further modifies or re-predicts the progression of one or more predicted values of the first amount of electric power supply by using wind information, and

the image includes an image of a windward sky viewed from the photovoltaic power generation equipment.

5-10. The program according to any one of supplementary notes 5-1 to 5-9, in which,

in the prediction method, the computer further outputs at least one type of information out of notification information and control information, based on a comparison result between a modified or re-predicted predicted value of the first amount of electric power supply and a predicted value of an amount of electric power demand at the supply target, and

the control information is information for controlling at least one of an amount of electric power supply to the supply target and the amount of electric power demand.

### REFERENCE SIGNS LIST

10 Prediction apparatus
20 Image capture unit
30 Prediction system
50 Supply target
52 Photovoltaic power generation equipment
54 Source of electric power supply
60 Electric power system grid
62 Electric power plant
110 Acquisition unit
120 Advance prediction unit
122 First trained model
124 Second trained model
130 Prediction unit
132 Third trained model
140 Storage unit
150 Output unit
160 Actual value acquisition unit
170 Change information acquisition unit
180 Image acquisition unit
1000 Computer

What is claimed is:

1. A prediction apparatus comprising:
at least one memory configured to store instructions; and
at least one processor configured to execute the instructions to perform operations comprising:
acquiring a progression of one or more predicted values of a first amount of electric power supply from a source of electric power supply including at least one piece of photovoltaic power generation equipment to a supply target; and
in a case where a predetermined condition is satisfied, modifying or re-predicting the progression of one or more predicted values of the first amount of electric power supply by using an image acquired by capturing an image of a sky around the photovoltaic power generation equipment.

2. The prediction apparatus according to claim 1, wherein
the predetermined condition includes at least one of a condition (1) and a condition (2),
the condition (1) is that a ratio of a predicted value of an amount of electric power demand at the supply target to a predicted value of the first amount of electric power supply satisfies a predetermined first criterion, and
the condition (2) is that a difference between an actual value and a predicted value of the first amount of electric power supply satisfies a predetermined second criterion.

3. The prediction apparatus according to claim 1, wherein
the predetermined condition includes a condition related to at least one item out of electric power supply from an electric power system grid to the supply target and electric power supply from the source of electric power supply to the electric power system grid.

4. The prediction apparatus according to claim 3, wherein
the predetermined condition includes at least one of a condition (3) and a condition (4),
the condition (3) is reception of information indicating that a second amount of electric power supply being an amount of electric power supply from the electric power system grid to the supply target needs to be changed, and
the condition (4) is reception of information indicating that a third amount of electric power supply being an amount of electric power supply from the source of electric power supply to the electric power system grid needs to be changed.

5. The prediction apparatus according to claim 1, wherein
the predetermined condition includes a condition related to electric power supply based on renewable energy to the supply target.

6. The prediction apparatus according to claim 5, wherein
the predetermined condition includes a condition (5), and
the condition (5) is that a difference between an amount of electric power supply based on renewable energy to the supply target and an amount of electric power demand at the supply target, or a cumulative value of the difference satisfies a third criterion.

7. The prediction apparatus according to claim 1, wherein
modifying or re-predicting the progression of one or more predicted values of the first amount of electric power supply comprises modifying or re-predicting the progression of one or more predicted values of the first amount of electric power supply by further using a date and time or information about a position of the sun.

8. The prediction apparatus according to claim 1, wherein
modifying or re-predicting the progression of one or more predicted values of the first amount of electric power supply comprises modifying or re-predicting the progression of one or more predicted values of the first amount of electric power supply by further using at least one item out of wind information and temperature.

9. The prediction apparatus according to claim 1, wherein
modifying or re-predicting the progression of one or more predicted values of the first amount of electric power supply comprises modifying or re-predicting the progression of one or more predicted values of the first amount of electric power supply by using wind information, and
the image includes an image of a windward sky viewed from the photovoltaic power generation equipment.

10. The prediction apparatus according to claim 1, further wherein
the operations further comprise outputting least one type of information out of notification information and control information, based on a comparison result between a modified or re-predicted predicted value of the first amount of electric power supply and a predicted value of an amount of electric power demand at the supply target, and
the control information is information for controlling at least one of an amount of electric power supply to the supply target and the amount of electric power demand.

11. A prediction system comprising:
the prediction apparatus according to claim 1; and
a camera that captures the image of the sky around the photovoltaic power generation equipment in a case where the predetermined condition is determined to be satisfied in the prediction apparatus.

12. A prediction method comprising, by one or more computers:
acquiring a progression of one or more predicted values of a first amount of electric power supply from a source of electric power supply including at least one piece of photovoltaic power generation equipment to a supply target; and,
in a case where a predetermined condition is satisfied, modifying or re-predicting the progression of one or more predicted values of the first amount of electric power supply by using an image acquired by capturing an image of a sky around the photovoltaic power generation equipment.

13. A non-transitory storage medium storing a program causing a computer to execute a prediction method comprising, by the computer:
acquiring a progression of one or more predicted values of a first amount of electric power supply from a source of electric power supply including at least one piece of photovoltaic power generation equipment to a supply target; and,
in a case where a predetermined condition is satisfied, modifying or re-predicting the progression of one or more predicted values of the first amount of electric power supply by using an image acquired by capturing an image of a sky around the photovoltaic power generation equipment.
